(19) United States
(12) Patent Application Publication
(10) Pub. No.: US 2026/0010734 A1
(43) Pub. Date: Jan. 8, 2026

(54) METHOD FOR GENERATING CORPUS DATA BASED ON LARGE MODELS

(71) Applicant: BEIJING BAIDU NETCOM SCIENCE TECHNOLOGY CO., LTD., Beijing (CN)

(72) Inventors: Yiqing WU, Beijing (CN); Shaoyun LV, Beijing (CN); Jie LIAO, Beijing (CN); Chunguang CHAI, Beijing (CN); Xiaopeng CUI, Beijing (CN); Liping OUYANG, Beijing (CN); Hong ZHU, Beijing (CN); Shuai YAO, Beijing (CN); Zizhan YU, Beijing (CN); Na ZHAO, Beijing (CN)

(21) Appl. No.: 19/327,658

(22) Filed: Sep. 12, 2025

(30) Foreign Application Priority Data
Jul. 29, 2025 (CN) 202511053125.5

(51) Int. Cl. G06F 40/35; G06F 40/40

(52) U.S. Cl. CPC G06F 40/35; G06F 40/40

(57) ABSTRACT

A method for generating corpus data based on large models is provided, which relates to the field of artificial intelligence technologies, and in particular to the fields of deep learning, large models, and intelligent question answering. The method includes: conducting a dialogue on a predetermined topic by using a plurality of role-based large models to obtain an utterance content of at least one of the role-based large models; performing dialogue strategy planning based on the utterance content by using a designated large model to obtain a dialogue strategy, where the dialogue strategy constrains a speaking pattern of the role-based large models during a dialogue process; and determining target corpus data related to the predetermined topic according to a target utterance content, where the target utterance content is generated by the role-based large models conducting a dialogue based on the dialogue strategy.

### CROSS-REFERENCE TO RELATED APPLICATION(S)

This application claims the benefit of Chinese Patent Application No. 202511053125.5 filed on Jul. 29, 2025, the whole disclosure of which is incorporated herein by reference.

### TECHNICAL FIELD

The present disclosure relates to the field of artificial intelligence technologies, and in particular to the fields of deep learning, large models, and intelligent question answering.

### BACKGROUND

A large language model (LLM) is an artificial intelligence model based on deep learning, which may be used to understand natural language to generate corresponding corpus content.

### SUMMARY

The present disclosure provides a method for generating corpus data based on large models, an electronic device, and a storage medium.

According to an aspect of the present disclosure, a method for generating corpus data based on large models is provided, including: conducting a dialogue on a predetermined topic by using a plurality of role-based large models to obtain an utterance content of at least one of the role-based large models; performing dialogue strategy planning based on the utterance content by using a designated large model to obtain a dialogue strategy, where the dialogue strategy constrains a speaking pattern of the role-based large models during a dialogue process; and determining target corpus data related to the predetermined topic according to a target utterance content, where the target utterance content is generated by the role-based large models conducting a dialogue based on the dialogue strategy.

According to another aspect of the present disclosure, an electronic device is provided, including: at least one processor; and a memory communicatively connected to the at least one processor, where the memory stores instructions executable by the at least one processor, and the instructions are configured to, when executed by the at least one processor, cause the at least one processor to implement the method provided in embodiments of the present disclosure.

According to another aspect of the present disclosure, a non-transitory computer-readable storage medium having computer instructions therein is provided, and the computer instructions are configured to cause a computer to implement the method provided in embodiments of the present disclosure.

It should be understood that the content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The Accompanying Drawings are Used for Better Understanding of the Solution and do not Constitute any Limitation to the Present Disclosure. In the Accompanying Drawings:

FIG. 1 schematically shows an exemplary system architecture to which a method and apparatus for generating corpus data based on large models may be applied according to an embodiment of the present disclosure;

FIG. 2 schematically shows a flowchart of a method for generating corpus data based on large models according to an embodiment of the present disclosure;

FIG. 3 schematically shows an application scenario diagram of a method for generating corpus data based on large models according to an embodiment of the present disclosure;

FIG. 4 schematically shows an application scenario diagram of a method for generating corpus data based on large models according to another embodiment of the present disclosure;

FIG. 5 schematically shows a flowchart of a method for generating corpus data based on large models according to another embodiment of the present disclosure;

FIG. 6 schematically shows a block diagram of an apparatus for generating corpus data based on large models according to an embodiment of the present disclosure;

FIG. 7 schematically shows a structural block diagram of an artificial intelligence agent according to an embodiment of the present disclosure; and

FIG. 8 shows a schematic block diagram of an example electronic device that may be used to implement the method for generating corpus data based on large models according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

In the technical solutions of the present disclosure, the acquisition, storage, and application of user personal information all comply with relevant laws and regulations, take necessary confidentiality measures, and do not violate public order and good customs.

The inventors have found that a large language model may be used by users to generate various types of files according to user requirements. For example, a large language model may be used to generate news releases, scripts and other text contents by processing requirement texts of users. In another example, a large language model may be used to generate information in various formats such as tables and codes to satisfy diversified user requirements. However, a corpus content generated by a large language model may have defects in semantic quality, making it difficult to accurately satisfy actual requirement intention of users.

The present disclosure provides a method and apparatus for generating corpus data based on large models, an intelligent agent, an electronic device, and a storage medium. The method for generating corpus data based on large models includes: conducting a dialogue on a predetermined topic by using a plurality of role-based large models to obtain an utterance content of at least one of the role-based large models; performing dialogue strategy planning based on the utterance content by using a designated large model to obtain a dialogue strategy, where the dialogue strategy constrains a speaking pattern of the role-based large models during the dialogue process; and determining target corpus data related to the predetermined topic according to a target utterance content, where the target utterance content is generated by the role-based large models conducting a dialogue based on the dialogue strategy.

According to embodiments of the present disclosure, during a process in which a plurality of role-based large models conduct a dialogue on a predetermined topic, a designated large model may perform dialogue strategy planning according to the utterance content to constrain the speaking pattern of at least one role-based large model during the dialogue process. Thus, the role-based large models constrained by the dialogue strategy may output a target utterance content with a high degree of semantic matching with the predetermined topic, thereby avoiding situations where the plurality of role-based large models have hallucinations such as semantic deviation of the utterance content from the predetermined topic during the dialogue process. Therefore, target corpus data related to the predetermined topic may be constructed based on the target utterance content, which improves a semantic relevance degree between the target corpus data and the predetermined topic, thereby enhancing the quality of the target corpus data and satisfying the actual requirements of a target object.

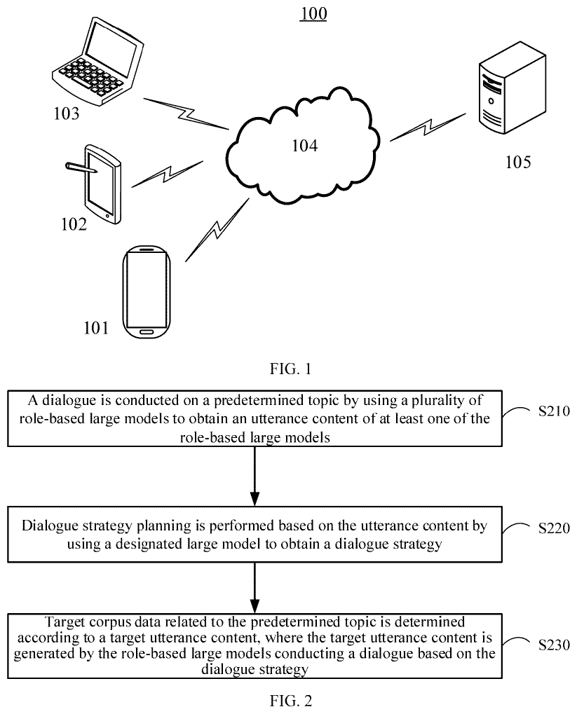

FIG. 1 schematically shows an exemplary system architecture to which a method and apparatus for generating corpus data based on large models may be applied according to an embodiment of the present disclosure.

It should be noted that FIG. 1 is merely an example of the system architecture to which embodiments of the present disclosure may be applied, so as to help those skilled in the art understand technical contents of the present disclosure. However, it does not mean that embodiments of the present disclosure may not be applied to other devices, systems, environments or scenarios. For example, in another embodiment, the exemplary system architecture to which the method and apparatus for generating corpus data based on large models may be applied may include a terminal device, but the terminal device may implement the method and apparatus for generating corpus data based on large models provided in embodiments of the present disclosure without interacting with a server.

As shown in FIG. 1, a system architecture 100 according to this embodiment may include a first terminal device 101, a second terminal device 102, a third terminal device 103, a network 104, and a server 105. The network 104 serves as a medium for providing a communication link between the first terminal device 101, the second terminal device 102, the third terminal device 103, and the server 105. The network 104 may include various types of connections, such as wired and/or wireless communication links.

The first terminal device 101, the second terminal device 102, and the third terminal device 103 may be used by a user to interact with the server 105 through the network 104 to receive or send messages, etc. The first terminal device 101, the second terminal device 102, and the third terminal device 103 may be installed with various communication client applications, such as knowledge reading applications, web browser applications, search applications, instant messaging tools, email clients and/or social platform software, etc. (for example only).

The first terminal device 101, the second terminal device 102, and the third terminal device 103 may be various electronic devices having display screens and supporting web browsing, including but not limited to smart phones, tablet computers, laptop computers, and desktop computers, etc.

The server 105 may be a server providing various services, such as a background management server (for example only) that provides support for content browsed by the user using the first terminal device 101, the second terminal device 102, and the third terminal device 103. The background management server may analyze and process received data such as a user request, and return a processing result (such as a web page, information or data acquired or generated according to the user request) to the terminal devices.

It should be noted that the method for generating corpus data based on large models provided in embodiments of the present disclosure may generally be performed by the first terminal device 101, the second terminal device 102, or the third terminal device 103. Accordingly, the apparatus for generating corpus data based on large models provided in embodiments of the present disclosure may be disposed in the first terminal device 101, the second terminal device 102, or the third terminal device 103.

Alternatively, the method for generating corpus data based on large models provided in embodiments of the present disclosure may generally be performed by the server 105. Accordingly, the apparatus for generating corpus data based on large models provided in embodiments of the present disclosure may generally be disposed in the server 105. The method for generating corpus data based on large models provided in embodiments of the present disclosure may also be performed by a server or server cluster different from the server 105 and capable of communicating with the first terminal device 101, the second terminal device 102, the third terminal device 103, and/or the server 105. Accordingly, the apparatus for generating corpus data based on large models provided in embodiments of the present disclosure may be disposed in a server or server cluster different from the server 105 and capable of communicating with the first terminal device 101, the second terminal device 102, the third terminal device 103, and/or the server 105.

It should be understood that the numbers of terminal devices, networks, and servers shown in FIG. 1 are merely illustrative. According to implementation needs, any number of terminal devices, networks, and servers may be provided.

FIG. 2 schematically shows a flowchart of a method for generating corpus data based on large models according to an embodiment of the present disclosure.

As shown in FIG. 2, the method for generating corpus data based on large models includes operation S210 to operation S230.

In operation S210, a dialogue is conducted on a predetermined topic by using a plurality of role-based large models to obtain an utterance content of at least one of the role-based large models.

In operation S220, dialogue strategy planning is performed based on the utterance content by using a designated large model to obtain a dialogue strategy.

In operation S230, target corpus data related to the predetermined topic is determined according to a target utterance content, where the target utterance content is generated by the role-based large models conducting a dialogue based on the dialogue strategy.

According to an embodiment of the present disclosure, the role-based large model may be constructed based on a large language model and generate an utterance content according to an input information. The plurality of role-based large models may be different large models. For example, the plurality of role-based large models may be obtained by fine-tuning based on different training data, or the plurality of role-based large models may generate utterance contents matching prompt information indicated by different prompt words.

According to an embodiment of the present disclosure, the utterance content may include a text expressed in the form of natural language, such as a conversation text, an intelligent customer service reply text, a script dialogue text, and the like. However, the utterance content is not limited thereto, and may further include content in any data format such as tables, codes, and icons. The specific data format of the utterance content is not limited in embodiments of the present disclosure.

According to an embodiment of the present disclosure, conducting a dialogue on a predetermined topic by using a plurality of role-based large models may include conducting an interactive dialogue by using the plurality of role-based large models, so that the role-based large models may generate a new utterance content through semantic understanding of the predetermined topic and the utterance content that has been already output.

According to an embodiment of the present disclosure, the dialogue strategy is used to constrain a speaking pattern of the role-based large models during the dialogue process. The speaking pattern may include a speaking order of the plurality of role-based large models, a speaking frequency of a designated role-based large model during the dialogue process, or the like, which are used to control the output of utterance content of the plurality of role-based large models during the dialogue process.

In some embodiments, the speaking pattern may further indicate a dialogue pattern such as a group dialogue of the plurality of role-based large models with respect to the predetermined topic. Thus, it is possible to flexibly control the plurality of role-based large models to conduct a group dialogue on the predetermined topic, thereby further improving the richness and diversity of utterance content and consequently improving the diversity and quality of the target corpus data.

In some embodiments, the speaking pattern represented by the dialogue strategy may further indicate content attributes such as topic semantics, expression manner, and expression style of the utterance content to be output by the role-based large models, so as to improve the quality of utterance content output by the role-based large models based on the dialogue strategy.

In some embodiments, the designated large model may be a large language model different from the role-based large models. The designated large model may plan the dialogue strategy for the plurality of role-based large models by performing semantic understanding on one or more utterance contents that have been already generated during the dialogue process, so that the dialogue strategy may prompt the plurality of role-based large models to conduct a high-quality dialogue according to a strategy content such as the speaking pattern and the content attribute requirements indicated by the dialogue strategy, thereby outputting a target utterance content that satisfies a quality requirement condition related to the predetermined topic.

According to an embodiment of the present disclosure, determining the target corpus data based on the target utterance content may include fusing target utterance contents and utterance contents respectively output by the plurality of role-based large models to obtain the target corpus data. Alternatively, the target corpus data may further include an annotation information related to the target utterance content and the utterance content. For example, the target corpus data may include a plurality of target utterance contents and the corresponding dialogue strategy contents, thereby achieving a convenient annotation of the target utterance content and the utterance content, and improving the efficiency of corpus data annotation and the quality of corpus data.

In some embodiments, the target corpus data may serve as sample data for testing or training a designated language model. The target corpus data may include the utterance contents respectively output by the plurality of role-based large models, the target utterance content, and the strategy content in the dialogue strategy. By fine-tuning the designated language model based on the target corpus data, the language model may learn to speak or conduct a dialogue on the predetermined topic according to the dialogue strategy. Thus, the trained language model may communicate with a real user or provide a question-answering reply in specific scenarios such as after-sales services for designated product or news release writing on a specified topic, thereby improving the quality of reply information in relevant specific scenarios and enhancing user experience.

In some embodiments, the predetermined topic may include a news release topic, a financial accounting project topic, a discussion viewpoint topic, and the like. The target corpus related to the predetermined topic may include news releases, financial accounting document contents, dialogue corpus content related to discussion viewpoints, and other corpus content related to specific requirement scenarios. The designated large model may perform dialogue strategy planning based on the utterance content during the dialogue process of the role-based large models, and the plurality of role-based large models may be promptly controlled based on the dialogue strategy to conduct a dialogue according to a speaking pattern that matches a requirement condition of the predetermined topic, so that the target utterance content may be further matched with the predetermined topic, and the target corpus data may meet requirement conditions of specific requirement scenarios, thereby satisfying actual requirement intention of the target object and improving the quality of the generated target corpus data.

In some embodiments, performing dialogue strategy planning based on the utterance content by using the designated large model to obtain the dialogue strategy may include: based on a requirement information input by the target object as a requirement prompt information, prompting the designated large model to perform dialogue strategy planning through semantic understanding of the utterance content and the predetermined topic, so that the generated dialogue strategy may be used to control the role-based large models to accurately output a target utterance content that meets the requirement condition indicated by the requirement information.

In some embodiments, conducting a dialogue on the predetermined topic by using the plurality of role-based large models may include: conducting a dialogue on the predetermined topic by using the plurality of role-based large models based on an initial dialogue strategy.

According to an embodiment of the present disclosure, the initial dialogue strategy is determined by the designated large model performing dialogue strategy planning according to the predetermined topic.

For example, before the plurality of role-based large models conduct a dialogue, the designated large model may process the predetermined topic and a model capability description information describing model capabilities of the plurality of role-based large models, and obtain an initial dialogue strategy for controlling the plurality of role-based large models to conduct a dialogue on the predetermined topic. Thus, the designated large model may sufficiently understand the respective capability attributes of the plurality of role-based large models, and then output the initial dialogue strategy to control the speaking order, speaking frequency, speaking style, word count range for each output utterance content, structured format requirements of the utterance content, and other strategy content of the plurality of role-based large models during the dialogue process. In this way, the plurality of role-based large models may conduct a relatively accurate dialogue around the predetermined topic from an initial stage of the dialogue, so that the output utterance content may meet the requirement condition indicated by the strategy content of the initial dialogue strategy. Accordingly, the accuracy of subsequent dialogue strategy generation may be improved, and further improvements may be achieved in the quality of the target utterance content and the content quality of the target corpus data.

In some embodiments, before the plurality of role-based large models conduct a dialogue, the target object is allowed to input requirement configuration information respectively related to the plurality of role-based large models on an interactive interface, so that the designated large model may perform dialogue strategy planning based on the input requirement configuration information and output the initial dialogue strategy.

In an embodiment, the requirement configuration information may include the predetermined topic, a role attribute of the role-based large model, a model name of the role-based large model, a model version identifier, a role responsibility description information, and the like. The role attribute may include domain expert, user role, reviewer role, arbitrator role, and the like. By using the role responsibility description as a prompt information, a role-based large model corresponding to a particular role attribute may process a contextual utterance content during the dialogue process according to the role attribute requirement indicated by the role responsibility description and generate an utterance content matching the role attribute requirement. For example, a role-based large model having an arbitrator role attribute may perform a viewpoint arbitration on the utterance content output by other role-based large models arguing about a predetermined discussion topic, and output an arbitration utterance content to adjust a dialogue development process of the plurality of role-based large models during the dialogue process.

In an embodiment, the requirement configuration information may further include a speaking style attribute, which may indicate a speaking style such as a concise style, a lively style, a professionally technical style, a dialogue direction guiding style, or the like. The speaking style attribute may serve as a style prompt information in the initial dialogue strategy to prompt the role-based large models to output an utterance content that matches the speaking style indicated by the corresponding speaking style attribute.

For example, the initial dialogue strategy may include a speaking style prompt information corresponding to role-based large model A, where the speaking style prompt information indicates a dialogue direction guiding style. In this case, role-based large model A may output an utterance content such as: “Please answer from a data perspective” or “Please provide three suggestions”. This guides other role-based large models to speak according to the guiding utterance content output by role-based large model A, thereby improving the quality of the utterance content.

It should be noted that the initial dialogue strategy and the dialogue strategy may include the same or similar types of strategy content. For example, the strategy content of the dialogue strategy may also include a style prompt information to continuously control the dialogue of the plurality of role-based large models during the dialogue process.

In some embodiments, the dialogue strategy and the initial dialogue strategy may be used to control the plurality of role-based large models to conduct a dialogue based on at least one of a parallel speaking pattern, a serial speaking pattern, or a hybrid speaking pattern.

The parallel speaking pattern is suitable for scenarios that require a plurality of role-based large models to speak actively, such as “brainstorming” or “viewpoint collision”. In the parallel speaking pattern, a plurality of role-based large models may be invoked simultaneously for parallel output. Additionally, in the parallel speaking pattern, the plurality of role-based large models may be divided into several “speaking groups”, and a plurality of role-based large models within each speaking group may conduct a discussion dialogue on a specific topic content. By controlling the plurality of role-based large models to conduct a dialogue in parallel based on the parallel speaking pattern, it is possible to simultaneously generate multiple versions of target dialogue content, thereby facilitating a rapid generation of target corpus data based on the target dialogue content and shortening the waiting time for generating high-quality target corpus data.

In some embodiments, the designated large model may simulate a host attribute to trigger an initial dialogue strategy or a dialogue strategy that includes the parallel speaking pattern at a particular stage, so as to control each role-based large model to output an utterance content according to the context content during the dialogue process and the predetermined topic. The output utterance content may be associated with a group number identifier in the parallel speaking pattern, and the target corpus content may be obtained by semantic fusion of a plurality of group number identifiers and the corresponding group utterance content.

The serial speaking pattern is applicable to specific scenarios where a plurality of role-based large models are required to speak in sequence, such as “deductive discussion” or “gap-filling”. The serial speaking pattern in the dialogue strategy may indicate the speaking order and speaking frequency of the plurality of role-based large models during the dialogue on the predetermined topic.

For example, a reviewer role-based large model having a reviewer role attribute may be required to perform an utterance content generation task after an expert role-based large model has output an utterance content and passed a self-check. In this way, the expert role-based large model may first output an utterance content representing an answer, and then the reviewer role-based large model may supplement or challenge the viewpoints in the answer of the expert role-based large model. Accordingly, by means of the serial speaking pattern, a context between a plurality of dialogue contents may be completely conveyed during the dialogue process, thereby improving the semantic coherence and consistency between a plurality of target utterance contents and enhancing the quality of the target corpus data.

The hybrid speaking pattern may refer to a speaking pattern in which a dialogue is conducted by combining the parallel speaking pattern and the serial speaking pattern during the dialogue process of the plurality of role-based large models. For example, the plurality of role-based large models may first be controlled based on the parallel speaking pattern to output an utterance content or a target utterance content representing a plurality of preliminary viewpoints. Then, by performing quality scoring or manual interactive selection on the utterance content or target utterance content, the serial speaking pattern may be triggered to control the plurality of role-based large models to conduct an in-depth discussion dialogue on a specific viewpoint related to the predetermined topic, thereby generating a new target utterance content.

In some embodiments, performing dialogue strategy planning based on the utterance content by using the designated large model to obtain the dialogue strategy may further include: performing semantic understanding on the utterance content by using the designated large model to obtain a content quality understanding result; performing a speaking weight adjustment on the role-based large model corresponding to the utterance content according to the content quality understanding result to obtain a speaking weight for the role-based large model; and determining the dialogue strategy based on the speaking weight.

According to an embodiment of the present disclosure, the content quality understanding result may refer to a quality evaluation result of the utterance content. For example, the content quality understanding result may include a score of a quality indicator on any one or more dimensions, such as semantic logical coherence, semantic consistency, relevance degree between the utterance content and the topic, and speaking style quality. The score of the quality indicator may serve as the quality evaluation result.

In some embodiments, a trained evaluation large model may perform semantic understanding on one or more utterance contents based on an evaluation prompt word to obtain the content quality understanding result. The trained large model may be a designated large model different from the host large model used for the dialogue strategy planning, thereby improving the accuracy of the content quality understanding result and further enhancing the effectiveness and real-time performance of the dialogue strategy.

According to an embodiment of the present disclosure, the speaking weight represents an expected degree of speaking participation of a role-based large model during the dialogue process. For example, the speaking weight may indicate a weight related to the utterance content attribute of the corresponding role-based large model during the dialogue process, such as a speaking frequency, a word count limit of the utterance content, or a speaking order. The higher the speaking weight corresponding to the role-based large model, the more words the role-based large model may output in the utterance content, or the more frequently the role-based large model may output utterance content during the dialogue process, thereby increasing the participation degree of the role-based large model. Accordingly, reducing the speaking weight of a particular role-based large model may decrease the word count in the utterance content output by the particular role-based large model, or lower the frequency of the particular role-based large model outputting utterance content during the dialogue process.

In some embodiments, the speaking weight may be further used to prompt the plurality of role-based large models participating in the dialogue to pay attention to the utterance content output by the role-based large model corresponding to the speaking weight. For example, prompt words such as “Focus on the utterance content of role-based large model A regarding artificial intelligence technology, and output corresponding reply content” may be input to role-based large model B.

In some embodiments, the higher the speaking weight corresponding to a role-based large model, the earlier the speaking order of the role-based large model. Then an utterance content output by a role-based large model having a high speaking weight may guide other role-based large models to output a high-quality content based on contextual utterance content, thereby further improving the corpus content quality of the target utterance content generated by controlling the plurality of role-based large models to conduct a dialogue according to the dialogue strategy.

In some embodiments, the content quality understanding result includes a topic relevance information, which represents a semantic relevance degree between the utterance content and the predetermined topic. The semantic relevance degree may indicate whether the utterance content deviates from a semantic scope of the predetermined topic, or may further indicate a degree to which the semantics of the utterance content deviate from the semantic scope of the predetermined topic.

In some embodiments, performing a speaking weight adjustment on a role-based large model corresponding to the utterance content according to the content quality understanding result may include: performing a speaking weight adjustment on the role-based large model corresponding to the utterance content according to the topic relevance information.

For example, if the topic relevance information corresponding to the utterance content output by role-based large model A indicates that a semantic relevance value between the utterance content and the predetermined topic is lower than a predetermined threshold value, the current speaking weight of role-based large model A may be reduced.

For example, if the topic relevance information corresponding to the utterance content output by role-based large model B indicates that a semantic relevance value between the utterance content and the predetermined topic is higher than the predetermined threshold value, the current speaking weight of role-based large model B may be increased.

For example, if the topic relevance information corresponding to the utterance content output by role-based large model A indicates that the semantic relevance value between the utterance content and the predetermined topic is 0.9, a speaking weight of 0.9 associated with the semantic relevance value of 0.9 may be assigned to role-based large model A. Accordingly, by using the topic relevance information between the utterance contents respectively output by the plurality of role-based large models and the predetermined topic, the speaking weight of the role-based large model having a close semantic relationship with the predetermined topic may be dynamically increased. According to the adjusted speaking weight, the role-based large model may then conduct a dialogue based on the dialogue strategy, thereby improving the quality of content output by the role-based large models during the dialogue process, further enhancing the data quality of target corpus data, and avoiding excessive manual intervention during the dialogue process or excessive modification of the target utterance content, improving the generation efficiency of the target corpus data and reducing the complexity of interactive operations in generative tasks such as data annotation and file generation.

In some embodiments, the designated large model may further send prompt words representing the corresponding topic relevance information to the role-based large model, so that the role-based large model may generate a new utterance content according to the prompt words or adjust the content quality of subsequently output utterance content.

For example, if the topic relevance information corresponding to role-based large model B is a text information indicating “a high degree of deviation from the historical research topic”, the designated large model may send prompt words “your utterance content shows a high degree of deviation from the historical research topic, please regenerate utterance content” to role-based large model B, so as to control role-based large model B to regenerate a high-quality utterance content having a higher degree of relevance to the historical research topic, thereby achieving automatic adjustment of the quality of content output by the plurality of role-based large models during the dialogue process.

In some embodiments, the content quality understanding result may further include a context relevance information, which represents a semantic relevance between the utterance content and a context content generated during the dialogue process. The context content generated during the dialogue process may include at least one of an already generated utterance content and a target utterance content. The context relevance information in the content quality understanding result obtained by the designated large model through semantic understanding of the utterance content and the context content may include a context relevance value, a context relevance level, or the like.

In some embodiments, performing a speaking weight adjustment on a role-based large model corresponding to the utterance content according to the content quality understanding result includes: performing a speaking weight adjustment on the role-based large model corresponding to the utterance content according to the context relevance information.

For example, if the context relevance information corresponding to the utterance content output by role-based large model A indicates that a semantic relevance value between the utterance content and the context content is lower than a predetermined threshold value, it is possible to reduce the current speaking weight of role-based large model A.

For example, if the context relevance information corresponding to the utterance content output by role-based large model B indicates that a semantic relevance value between the utterance content and the context content is higher than the predetermined threshold value, it is possible to increase the current speaking weight of role-based large model B.

For example, if the context relevance information corresponding to the utterance content output by role-based large model A indicates that the semantic relevance value between the utterance content and the context content is 0.9, a speaking weight of 0.9 associated with the semantic relevance value of 0.9 may be assigned to role-based large model A. Accordingly, by using the context relevance information between the utterance contents respectively output by the plurality of role-based large models and the context content, the speaking weight of the role-based large model having a close semantic relationship with the context content may be dynamically increased. According to the adjusted speaking weight, the role-based large model may then conduct a dialogue based on the dialogue strategy, thereby improving the quality of the content output by the role-based large models during the dialogue process, further enhancing the data quality of the target corpus data. This may avoid excessive manual intervention during the dialogue process or excessive modification of the target utterance content, improve the generation efficiency of the target corpus data, and reduce the complexity of interactive operations in generative tasks such as data annotation and file generation.

In some embodiments, the designated large model may further send prompt words representing the corresponding context relevance information to the role-based large model, so that the role-based large model may generate a new utterance content according to the prompt words, or adjust the content quality of subsequently output utterance content.

For example, if the context relevance information corresponding to role-based large model B is a text information indicating “poor semantic relevance with other utterance content”, the designated large model may send prompt words “your utterance content has poor semantic relevance with other utterance content, please regenerate utterance content” to role-based large model B, so as to control role-based large model B to regenerate a high-quality utterance content having a high relevance degree to context, thereby achieving an automatic adjustment of the quality of content output by the plurality of role-based large models during the dialogue process.

Since the context relevance information may represent the semantic relevance such as semantic logical coherence and semantic integrity between the utterance contents respectively output by the plurality of role-based large models during the dialogue process and other utterance content generated during the dialogue process, the speaking weight of the role-based large model corresponding to the utterance content may be adjusted according to the context relevance information. In this way, a role-based large model whose output utterance content has a high degree of semantic relevance to the context may increase a speaking participation degree during the dialogue process, thereby improving the corpus data quality and the generation efficiency of the target corpus data.

In an embodiment, a context deviation warning information indicating “poor semantic relevance with other utterance content” may be displayed on the interactive interface, so that the target object may be promptly aware of the content quality of the utterance content output by each role-based large model during the current dialogue process, and may then input a requirement information through an interactive operation to control the designated large model to output a dialogue strategy that meets the requirements.

It should be noted that the types of strategy content included in the initial dialogue strategy involved in embodiments of the present disclosure may be the same as or similar to the types of strategy content in the dialogue strategy, which will not be repeated here.

In some embodiments, the speaking weight in the dialogue strategy or in the initial dialogue strategy may be further used to remove at least one role-based large model currently participating in the dialogue, or may be used to designate, from candidate large models that have not participated in the dialogue, a target role-based large model to participate in the dialogue. In this way, the designated large model may flexibly schedule a plurality of role-based large models to participate in the dialogue to generate a new high-quality utterance content, thereby improving the quality level of the target corpus data. The designated large model may also implement automatic flexible scheduling for the dialogue process, so as to enhance the generation efficiency of the target corpus data.

In an embodiment, the designated large model may determine a speaking token from a token pool based on the speaking weight, and distribute the speaking token to the role-based large model to control the role-based large model to output an utterance content.

In some embodiments, during the dialogue process, a host large model serving as the designated large model may, based on option elements such as “add role” or “remove role” displayed on the interactive interface according to the interactive operation of the target object, send a speaking weight token to the role-based large model indicated by the option elements. The speaking weight indicated by the speaking weight token may instruct the role-based large model to stop speaking or participate in speaking. In this way, when a sudden viewpoint supplementation is needed during the dialogue process, a new role-based large model may be quickly inserted based on the interactive operation of the target object to output an utterance content according to the context content and the predetermined topic.

In some embodiments, the dialogue strategy may further include a cooldown period for token distribution, which supports the configuration that the speaking weight token enters a “cooldown period” after being assigned to a role-based large model to perform an utterance content generation task. A cooldown period may be configured as one round or two rounds, for example, so that the role-based large model does not generate utterance content during the cooldown period which is one or two rounds after its current speaking, thereby avoiding the same role-based large model from excessively outputting utterance content consecutively. The dialogue strategy may further include a timeout protection for token distribution. Specifically, if a role-based large model experiences a call timeout or failure after being assigned a speaking weight token, the current speaking weight token is automatically skipped and reassigned to a next role-based large model. The dialogue strategy may further include a speaking weight token downgrade and fallback. Specifically, when multiple attempts to distribute a token to the designated role-based large model fail to meet a triggering condition, the role-based large model may be downgraded or removed, a manual editing operation may be performed to input an utterance content or another role-based large model may be invoked to intervene, and the fallback operation is recorded.

In some embodiments, the strategy content in the dialogue strategy may further include a topic convergence decision, which may indicate that the current context content output by the plurality of role-based large models already satisfies a requirement condition for the predetermined topic or any subtopic of the predetermined topic, so that the dialogue may be summarized, terminated, or transitioned to a new predetermined topic or a new subtopic. Accordingly, the semantic understanding capability of the designated large model may be used to control the termination of the dialogue process and the transition of subtopic, thereby improving the generation flexibility and efficiency of target corpus data.

In some embodiments, a topic convergence information indicated by the interactive operation of the target object may prompt the designated large model to control the plurality of role-based large models to: conduct a summarization dialogue, terminate the dialogue, or initiate a dialogue on a new predetermined topic or a new subtopic. This enhances the controllability of the target object over the process of generating the target corpus data.

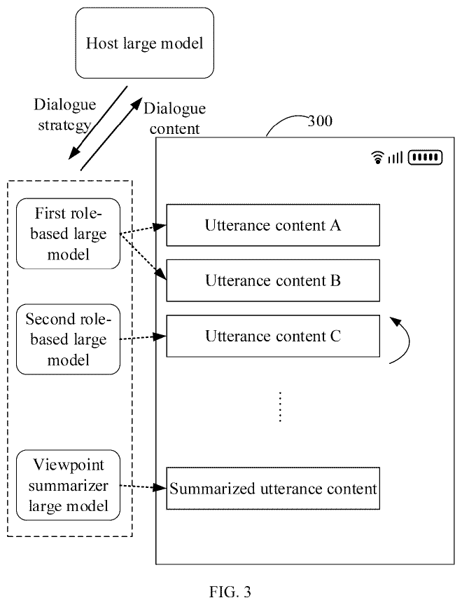

FIG. 3 schematically shows an application scenario diagram of a method for generating corpus data based on large models according to an embodiment of the present disclosure.

As shown in FIG. 3, in this application scenario, the designated large model is a host large model having a host attribute. The plurality of role-based large models may include a first role-based large model, a second role-based large model, and a viewpoint summarizer large model. Before the dialogue begins, the host large model performs dialogue strategy planning by processing the predetermined topic, the model capability description information of each role-based large model, and a requirement information configured by the target object for the predetermined topic, thereby obtaining an initial dialogue strategy. The host large model controls, through the initial dialogue strategy, the speaking order, the speaking frequency, and other speaking patterns of the first role-based large model and the second role-based large model with respect to the predetermined topic during the dialogue process. The utterance content generated by the plurality of role-based large models during the dialogue process is displayed on a first interactive interface 300.

During the dialogue conducted by the first role-based large model and the second role-based large model, the host large model may process already generated utterance content A, utterance content B, and utterance content C, where utterance content A and utterance content B serve as context content. The output content understanding result may include a context relevance information related to utterance content C, indicating that utterance content C has a defect of low contextual semantic relevance. In such a case, the speaking weight of the second role-based large model in the subsequent dialogue process may be reduced, and the second role-based large model may be instructed to perform a new utterance content generation task to generate new utterance content C.

In the process of controlling the plurality of role-based large models to conduct a dialogue based on the dialogue strategy including the adjusted speaking weight, the host large model may further perform semantic understanding of the utterance content to output a new dialogue strategy, thereby timely adjusting the speaking pattern of the plurality of role-based large models and the quality of the output utterance content. After the host large model performs semantic understanding of a plurality of already generated utterance contents, if the output content understanding result indicates that a plurality of utterance contents related to the predetermined topic need to be summarized, the dialogue strategy output by the host large model includes a prompt information for the viewpoint summarizer large model to perform summarization. The viewpoint summarizer large model is thus controlled to perform semantic summarization of the predetermined topic and the already generated contextual utterance content, and to output a summarized utterance content.

The target corpus data may be generated based on utterance content A, utterance content B, utterance content C . . . up to the summarized utterance content, together with the plurality of dialogue strategies and the initial dialogue strategy output by the host large model.

According to an embodiment of the present disclosure, the target utterance content is obtained based on the dialogue strategy by the plurality of role-based large models conducting a dialogue on the predetermined topic.

In some embodiments, obtaining the target utterance content based on the dialogue strategy by the plurality of role-based large models conducting a dialogue on the predetermined topic may include: controlling, by using the designated large model, the plurality of role-based large models to conduct a dialogue based on the dialogue strategy to obtain an intermediate utterance content; and determining the target utterance content in response to a target interactive operation performed by the target object on the intermediate utterance content.

According to an embodiment of the present disclosure, the intermediate utterance content may be output by the role-based large models. Controlling the plurality of role-based large models to conduct a dialogue based on the dialogue strategy by using the designated large model may include: according to strategy content information such as speaking order and speaking frequency in the speaking pattern represented by the dialogue strategy output by the designated large model, scheduling the corresponding role-based large models to perform an utterance content generation task based on the context content and the predetermined topic to output an intermediate utterance content.

In some embodiments, the intermediate utterance content may be obtained by a role-based large model performing a self-check task to review and modify the output initial utterance content, thereby outputting an intermediate utterance content that satisfies an utterance content quality condition.

In some embodiments, the target interactive operation performed by the target object on the intermediate utterance content may include an adoption operation for adopting the intermediate utterance content as the target utterance content. Accordingly, an intermediate utterance content for the target corpus data may be quickly generated through the adoption operation performed by the target object on any intermediate utterance content generated during the dialogue conducted on the predetermined topic by the plurality of role-based large models, thereby improving the efficiency and accuracy of controlling the plurality of role-based large models during the dialogue process.

In some embodiments, the target corpus data may include the related target utterance content and an operation information of the target interactive operation. For example, the operation information may carry an editing information of an editing operation performed on the intermediate utterance content.

In an example, the interactive interface may display an intermediate utterance content output by any role-based large model during the dialogue process. The intermediate utterance content may be displayed in an utterance content box and shown in light-colored characters. When the target object performs an adoption operation on at least one content word or content paragraph in the intermediate utterance content, the corresponding content word or content paragraph in the intermediate utterance content may be displayed in dark-colored characters, and the content word or content paragraph corresponding to the dark-colored characters may be determined as the target utterance content.

In some embodiments, the target interactive operation may further include an update operation. Determining a target utterance content in response to a target interactive operation performed by the target object on the intermediate utterance content may include: in response to an update operation on the intermediate utterance content, updating the intermediate utterance content according to the update operation by using the role-based large model to obtain an updated intermediate utterance content; and, in response to an adoption operation performed on the currently displayed intermediate utterance content on the interactive interface, determining the currently displayed intermediate utterance content as the target utterance content.

According to an embodiment of the present disclosure, the intermediate utterance content and the updated intermediate utterance content are displayed on the interactive interface. For example, the intermediate utterance content may be displayed on the interactive interface, and after the updated intermediate utterance content is generated, the intermediate utterance content may be removed from the interactive interface and the updated intermediate utterance content may be displayed on the interactive interface. Alternatively, both the intermediate utterance content and the updated intermediate utterance content may be simultaneously displayed on the interactive interface, so that the target object may perform an adoption operation after comparison.

In an example, the update operation may be a cancellation operation. The interactive interface may display the intermediate utterance content output by any role-based large model during the dialogue process. The intermediate utterance content displayed may be displayed in an utterance content box and shown in light-colored characters. If the target object performs a cancellation operation on at least one content word or content paragraph in the intermediate utterance content, the intermediate utterance content may be cleared, and the role-based large model may be instructed to re-perform an utterance content generation task to generate and display an updated intermediate utterance content. This process may continue until the target object performs an adoption operation on the currently generated intermediate utterance content, thereby determining the target utterance content.

In some embodiments, the update operation may further include an editing operation for editing the currently displayed intermediate utterance content. The editing operation may indicate content editing performed by the target object on the intermediate utterance content, such as deleting or inserting text, tables, or other content.

In some embodiments, a plurality of role-based large models may respectively perform utterance content generation tasks for the same role during the dialogue process, thereby obtaining intermediate utterance contents respectively output by the plurality of role-based large models. The update operation may further include a fusion operation, which is used to fuse a plurality of intermediate utterance contents related to the same role to obtain the target utterance content.

For example, the designated large model may perform semantic fusion on a plurality of explanation contents of a philosophical question selected by the user as the intermediate utterance contents, thereby obtaining the target utterance content.

Accordingly, by configuring a plurality of role-based large models for the same role participating in the dialogue to respectively generate intermediate utterance contents, it is possible to enhance the diversity and variety of the intermediate utterance contents. By performing semantic fusion on the plurality of intermediate utterance contents, it is possible to generate a high-quality target utterance content to improve the quality and generation efficiency of the target corpus data.

In some embodiments, the interactive interface may further display a content quality score related to one or more intermediate utterance contents. The content quality score may represent an evaluation result of the intermediate utterance content in terms of content quality metrics such as contextual relevance, topic relevance, and language fluency.

For example, for each intermediate utterance content output by a role-based large model, the content quality score may be determined in the following manner.

For a language fluency metric, the designated large model may perform a language fluency evaluation on the intermediate utterance content to obtain a language fluency evaluation result.

For a contextual relevance metric, a cosine similarity between the intermediate utterance content and the context content may be calculated as a contextual relevance evaluation result by using an attention network algorithm.

For a coverage and integrity metric, a coverage and integrity of the intermediate utterance content may be evaluated based on a predefined key element list including entities, intent points, and the like, to obtain a coverage and integrity evaluation result.

For a semantic logical consistency metric, a large language model may detect whether the internal semantics of the intermediate utterance content contains logical contradictions or logical leaps, so as to obtain a logical consistency detection result.

By fusing the language fluency evaluation result, the coverage and integrity evaluation result, the contextual relevance evaluation result, and the logical consistency detection result, and by performing quantification processing, the content quality score of the intermediate utterance content may be obtained. The content quality score may be displayed on the interactive interface to help the target object select a high-quality intermediate utterance content as the target utterance content.

For example, the target object may perform a fusion operation on a plurality of intermediate utterance contents of the same role. The designated large model may automatically select a plurality of intermediate utterance contents whose content quality scores satisfy a predetermined scoring condition for semantic fusion, so as to fuse high-score paragraphs or key phrases to generate an updated intermediate utterance content. The target object may then perform an adoption operation on the updated intermediate utterance content to obtain the target utterance content.

The plurality of role-based large models corresponding to the same role may be determined based on the interactive operation of the target object. For example, the target object may select the plurality of role-based large models based on version numbers, model names and other information of the plurality of role-based large models.

In some embodiments, the target corpus data may further include a detailed generation process information such as the intermediate utterance contents, the content quality scores corresponding to the intermediate utterance contents, and generation timestamps. Such information may allow relevant personnel to review or study the target utterance content based on the detailed generation process information in the target corpus data. Alternatively, such information may be used to train a language model so that the language model may clearly and comprehensively learn the detailed utterance content generation process, thereby improving the ability and adaptability of the language model in performing a content generation task related to the predetermined topic.

In some embodiments, the target corpus data may be determined based on the target utterance content and an operation information of the target interactive operation related to the target utterance content.

In an embodiment, the target utterance content in the target corpus data is related to an adoption operation performed by the target object. The target corpus data may include an operation information, an intermediate utterance content, and a target utterance content, which have a mapping relationship with each other. Accordingly, the target corpus data may be used to train a language model such that the language model may compare a difference between a target utterance content that satisfies the quality condition and an intermediate utterance content that fails to satisfy the quality condition, and learn the interaction information of the target interactive operations such as fusion operations, editing operations, cancellation operations, and adoption operations performed on the intermediate utterance content, thereby enhancing a content interaction capability of the language model in scenarios related to the predetermined topic.

In some embodiments, determining the target corpus data based on the operation information and the target utterance content may further include determining an adoption rate for each role-based large model based on the operation information. The adoption rate may indicate a statistical proportion of the intermediate utterance content output by a role-based large model that has been subjected to an adoption operation by the target object. For example, adoption rate=(number of intermediate utterance contents subjected to adoption operations)/(total number of intermediate utterance contents output). By using the target corpus data that includes the adoption rate, the performance of the language model may be reinforced, and the quality of the content output by the trained language model may be improved.

In an embodiment, if the adoption rate of a role-based large model is greater than 80%, then during an editing operation performed by the target object on the intermediate utterance content, the utterance content generation operation may be performed according to the content information edited by the target object. If the adoption rate of a role-based large model is less than 30%, the role-based large model may perform the utterance content generation operation according to a complete content information edited by the target object, or may prompt the target object to generate a target dialogue content according to the editing operation.

In some embodiments, controlling a plurality of role-based large models to conduct a dialogue based on the dialogue strategy by using the designated large model may further include: in response to a specified event related to the dialogue strategy being triggered, controlling, by using the designated large model, a target role-based large model to perform semantic understanding on the specified event based on an event prompt information corresponding to the specified event in the dialogue strategy to obtain an event feedback information. The target corpus data is determined based on the event feedback information and the target utterance content, and the specified event is determined by detecting the utterance content during the dialogue process.

According to an embodiment of the present disclosure, the specified event may be triggered based on a predetermined rule. The specified event may include, for example, a risky utterance content attribute event, a severe semantic conflict event, or an event of a content quality score falling below a score threshold. The designated large model may detect the utterance content generated by the plurality of role-based large models during the dialogue process, the operation information of the target interactive operation, an operating state of a computing device, and the like, to determine whether a specified event is triggered. Alternatively, the utterance content generated during the dialogue process, the operation information of the target interactive operation, an operating state of a computing device, and the like may be detected by a detection tool constructed based on a predetermined rule, so as to determine whether a specified event is triggered.

In some embodiments, an event prompt information corresponding to a specified event in the dialogue strategy may indicate a corresponding event response action in the case that the specified event is triggered. By using the designated large model to control the target role-based large model to perform semantic understanding of the triggered specified event based on the event prompt information, it is possible to generate an event feedback information that matches a response requirement intention represented by the event response action. Accordingly, the target corpus data may be generated based on the event feedback information, the target utterance content, the operation information of the target interactive operation, and other information, so that a language model to be trained may learn to timely output an event feedback information in response to a relevant specified event being triggered during the dialogue on the predetermined topic. This improves the quality of content output by the language model in relevant scenarios and further enhances the model capability of the language model.

In an embodiment, the specified event may include any one or more of the following events.

Risky content trigger event: triggered when the designated large model detects the occurrence of a predetermined risky keyword in the context content generated during the dialogue process, or when the content understanding result indicates that the sentiment tendency of the context content exhibits a specified negative emotion type. The event response action indicated by the corresponding event prompt information is to prompt a risk detection result such as a risky keyword or a risky emotion type, so as to control at least one role-based large model to output an utterance content that satisfies a risk-related requirement condition.

Content quality score event: triggered when the content quality score of any intermediate utterance content or of a predetermined number of intermediate utterance contents falls below a predetermined score threshold. The event response action indicated by the corresponding event prompt information is to prompt a role-based large model having a reviewer role attribute among the plurality of role-based large models to output a quality defect type in the context content according to the context content and the content quality score, so that other role-based large models may re-conduct a dialogue as the event feedback information according to the quality defect type.

Response duration event: triggered when an interval between dialogue rounds during the dialogue process exceeds a predetermined time threshold, or when the number of dialogue rounds exceeds a predetermined round count threshold. The event response action indicated by the corresponding event prompt information is to prompt a target role-based large model having a viewpoint summarization capability to summarize and generalize the context content generated during the dialogue process and output a viewpoint summarization utterance content as an event feedback information.

Specified interactive operation event: triggered when an operation information of a specified type of interactive operation is detected during the dialogue process. The operation information may be, for example, an input information entered by the target object such as “change the direction of viewpoint discussion” or “discuss in the next round”. The event response action indicated by the corresponding event prompt information is to prompt a plurality of role-based large models, as target role-based large models, to perform utterance content generation tasks according to the requirements of the input operation information and output utterance contents that satisfy the requirements as the event feedback information.

Viewpoint conflict event: triggered if a viewpoint contradiction condition or a viewpoint conflict condition is satisfied after a viewpoint conflict detection is performed according to the context content. The event response action indicated by the corresponding event prompt information is to invoke a target role-based large model having a viewpoint arbitrator attribute to respond to the viewpoint conflict existing in the context content, thereby obtaining an event feedback response information.

Arbitrator rule triggering: this event is triggered if the content quality score of an utterance content that a reviewer role-based large model must generate to respond to a question-type utterance content output by a designated role-based large mode falls below a score threshold, or if the content quality score of an utterance content of an expert role-based large model on a specified subtopic falls below the score threshold. The event response action indicated by the corresponding event prompt information is to invoke a target large model having an arbitrator role attribute to output a reply utterance content based on the context content.

Custom events: a custom event triggering rule may be defined based on the interactive operation of the target object. For example, a specified event may be triggered if a reply utterance content output by an expert role-based large model exceeds 5000 characters in length, or if an utterance content output by a reviewer role-based large model is delayed for more than 120 seconds.

In an embodiment, a system log may record log data such as a timestamp of a specified event being triggered, a type of the specified event, an utterance content related to the specified event, an event feedback information. The log data and the dialogue strategy may jointly serve as annotation metadata related to the utterance content and the target utterance content to perform annotation and generate target corpus data.

In some embodiments, the target corpus data may further include content understanding results corresponding to the utterance contents output by various role-based large models, so that the target object may intuitively understand the content quality and content attributes corresponding to the target utterance contents in the target corpus data. Accordingly, a language model to be trained may learn from the content understanding results and the target utterance content, and may be fine-tuned such that the trained language model is adapted to interaction scenarios related to the predetermined topic, thereby improving the model performance of the language model.

For example, the target corpus data may include the utterance content and target utterance content output by the plurality of role-based large models, as well as the strategy content of the dialogue strategy output by the designated large model to each role-based large model, including speaking order, triggering events, role addition or removal, convergence node insertion, scheduling commands, and so on. The target corpus data may store the strategy content and the target utterance content in a structured data file, so that the large language model may accurately learn dialogue capabilities for dialogue scenarios related to a predetermined topic, thereby improving a training efficiency of the language model.

In some embodiments, the target corpus data may be determined based on the dialogue strategy, the target utterance content, and a thinking process information of the role-based large model during execution of an utterance content generation task.

According to an embodiment of the present disclosure, the thinking process information may represent a chain of thought, a tree of thought, and the like of a role-based large model during execution of an utterance content generation task. The thinking process information may include a plurality of target tasks and a dependency relationship between the plurality of target tasks, so that the role-based large model may perform a plurality of target tasks according to the dependency relationship and the thinking process information, and output an utterance content.

For example, the plurality of target tasks may include a thinking task, which may be represented by multiple tasks in the following examples.

Preliminary reasoning task: rapidly generating candidate answers or solutions based on the dialogue context.

Self-check task: checking the consistency, logic, and completeness of a previous thinking result, and outputting a check report or a list of questions.

Iterative thinking task: supplementing, correcting, or reconstructing previous thinking content based on a self-check feedback or a tool result.

Summarization and extraction task: extracting key elements, concepts, or facts from complex information, and generating a concise summary or a list of key points.

Format conversion task: converting textual content into different formats such as question-answer pairs, step lists, code comments, or tables.

Classification and intent recognition task: determining user intent, sentiment tendency, or text type, and providing labels for subsequent processing. Decision-making and strategy formulation task: evaluating the advantages and disadvantages of multiple options in a multi-option scenario, and providing an optimal or feasible strategy.

For another example, the plurality of target tasks may include a tool invocation task. A tool invocation task refers to a task where a role-based large model invokes a designated tool resource to perform a tool processing task and obtains a tool invocation task execution result output by the tool resource. The tool invocation task may include, for example, one or more tool resources. The tool resources may include, for example, a document retrieval tool, a web search tool, an image processing tool, a language translation tool, a multimodal data fusion tool, and the like.

Document retrieval tool: performing information extraction such as document summarization and question answering, performing a database query task, and parsing a query result. Web search tool: searching pages and acquiring relevant page contents. Code execution and debugging tool: running program scripts in a specified language and returning program script execution results. Image processing tool: performing understanding and question answering on image content, or generate images from natural language.

In some embodiments, the thinking process information may be displayed on the interactive interface in the form of a thinking topology that includes nodes and edge relationships. This facilitates modifying target tasks and dependency relationships during the thinking process of a role-based large model performing an utterance content generation task, ensuring that the role-based large model outputs an utterance content that satisfies the requirement intention of the target object.

In some embodiments, the target corpus data may be used to train a language model to be trained. The language model to be trained may be constructed based on principles of large language models, and the number of model parameters of the language model may be smaller than that of the role-based large model configured to perform utterance content generation tasks. Accordingly, the language model may be trained based on structured thinking process information and corpus content, thereby achieving full distillation of model capabilities of a large model with a great parameter scale and strong performance into a language model with a small parameter scale. The trained language model may be deployed on a computing device such as a server to enhance capabilities of the computing device, so as to meet requirements of specific scenarios such as intelligent customer service, knowledge question answering, and script creation, thereby improving user experience and reducing computational overhead.

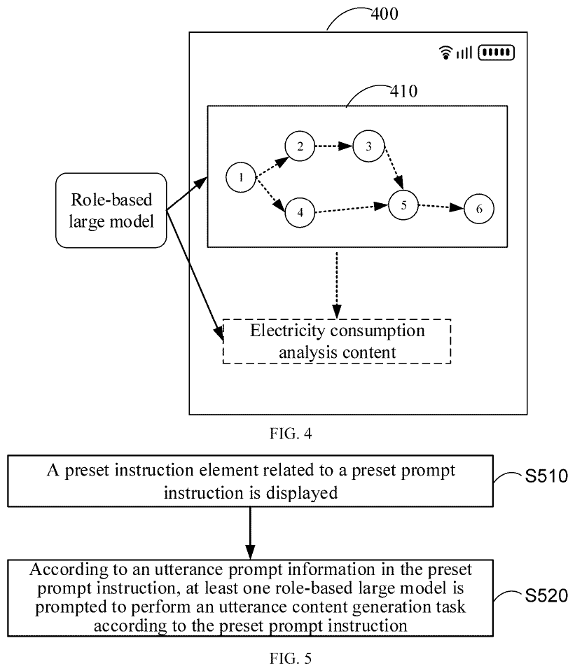

FIG. 4 schematically shows an application scenario diagram of a method for generating corpus data based on large models according to another embodiment of the present disclosure.

As shown in FIG. 4, a second interactive interface 400 displays a thinking topology 410 of a role-based large model performing an utterance content generation task. The thinking topology 410 may include a plurality of nodes and edge relationships between the nodes. The plurality of nodes may represent a plurality of target tasks, and the plurality of target tasks are performed according to the dependency relationships indicated by the edge relationships. Node 1 may represent a first target task, which may be a thinking task for task planning corresponding to a question “Predict the electricity consumption variation of Company A in 2026”. Node 2 represents a tool scheduling task for acquiring revenue reports of Company A over the past three years. Node 3 represents a tool scheduling task for performing semantic understanding on the revenue reports of Company A over the past three years to generate a content of analyzing the product output variation of Company A over the past three years and a content of predicting the product output of Company A in 2026.

Node 4 may represent a data search task for acquiring electricity consumption variation data of Company A over the past three years. Node 5 may represent a tool scheduling task for performing semantic analysis on the electricity consumption variation data of Company A over the past three years, the content of analyzing the product output variation, and the content of predicting the product output in 2026, by using the role-based large model, and for outputting a content for analyzing the electricity consumption of Company A. Node 6 represents a thinking task for performing self-check on the content of analyzing the electricity consumption of Company A. Thus, the utterance content output by the role-based large model may be an electricity consumption analysis content for Company A in 2026. The electricity consumption analysis content may include diverse data such as multiple text paragraphs, tables, and charts.

The plurality of nodes and edge relationships in the thinking topology 410 may indicate a plurality of target tasks and a mapping relationship between the target tasks during a thinking process of a role-based large model performing an utterance content generation task. The target object is allowed to perform an interactive operation on the thinking topology 410 to add, remove, or replace any node or edge relationship, thereby updating the thinking process information based on the interactive operation performed on the second interactive interface 400. Accordingly, the role-based large model may perform the utterance content generation task based on the plurality of target tasks and dependency relationships in the updated thinking process information, so as to output the electricity consumption analysis content.

It should be noted that the information acquisition in any embodiment of the present disclosure, including but not limited to revenue reports and electricity consumption data, is performed after obtaining authorization from relevant personnel or organizations. Before acquiring the data, the actual purpose of the data acquisition is disclosed to satisfy the actual requirements of the target object with data access permissions. Moreover, necessary encryption or desensitization measures are applied to the acquired data to avoid information leakage, which complies with relevant laws and regulations and does not violate public order and good customs.

In some embodiments, the method for generating corpus data based on large models provided in embodiments of the present disclosure may further include providing a tool invocation subsystem. According to the tool invocation subsystem, the target object may configure tool resources to be invoked and manage complex tool resource invocation workflows on the same interactive interface as the real intermediate utterance content or utterance content, thereby obtaining authentic and reliable tool execution sample data. Furthermore, with the aid of functions such as simulation, monitoring, and automatic recommendation, a configuration difficulty and an operational risk may be significantly reduced. As a result, high-fidelity, multi-scenario tool resources may be provided for diverse scenarios such as training language models and generating research reports or other specified requirement text.

A tool registration and description component may be provided to manage tool metadata. The tool metadata includes a tool description information required for each tool resource when being invoked. The tool description information of the tool resource may include a tool name and version, an invocation parameter template, a result verification rule, a retry strategy such as timeout or retry count, and a tool invocation triggering condition.

The tool invocation subsystem may further include a service component configured to provide intelligent completion and validation services. The service component may automatically recommend tool resources suitable for invocation on the interactive interface, based on context content occurring during the dialogue process and historical invocation records, and may recommend search keywords, code snippets, or other input parameter values. Meanwhile, when configuring parameters for a tool invocation task, the service component may check configuration parameter conditions in real time, such as parameter types, required items, and range validity, and provide a correction prompt information.

FIG. 5 schematically shows a flowchart of a method for generating corpus data based on large models according to another embodiment of the present disclosure.

As shown in FIG. 5, the method for generating corpus data based on large models includes operation S510 to operation S520.

In operation S510, a preset instruction element related to a preset prompt instruction is displayed.

In operation S520, in response to a triggering operation on the preset instruction element and according to an utterance prompt information in the preset prompt instruction, at least one role-based large model is prompted to perform an utterance content generation task according to the preset prompt instruction.

According to an embodiment of the present disclosure, a role-based large model may conduct a dialogue with other role-based large models by performing an utterance content generation task. For example, the role-based large model may perform semantic understanding on a context content and a strategy content of a dialogue strategy, and output an utterance content.

According to an embodiment of the present disclosure, the preset prompt instruction may indicate a task requirement condition of an utterance content generation task that the target object currently requires the role-based large model to perform. For example, the preset prompt instruction may instruct the role-based large model to perform an utterance content generation task according to an utterance prompt information corresponding to requirement conditions such as “describe content in the form of table”, “simplify the answer”, “expand details”, “convert format”, or “list key points”, and to output an utterance content that matches the task requirement condition indicated by the utterance prompt information.

In some embodiments, the target object is allowed to edit an initial preset instruction element to generate a preset prompt instruction element that matches the task requirement condition. The preset prompt instruction may be configured with an utterance prompt information to facilitate a quick command control over at least one role-based large model during the dialogue process, thereby improving the generation efficiency of target corpus data.

In some embodiments, tool resources may also be invoked to run in a controlled sandbox environment with isolated file systems and network access, to prevent malicious code or data leakage. After the tool resource is invoked, an execution result of the tool resource, together with an utterance content or intermediate utterance content having a mapping relationship thereto, as well as context content, may be submitted to a designated large model for quality evaluation. A scope of evaluation includes, but is not limited to: completeness of the result (e.g., whether a target task execution result contains required fields), semantic matching degree (e.g., the relevance to the expected answer), and reliability assessment (e.g., source credibility score of search results obtained after the execution of the tool invocation task).

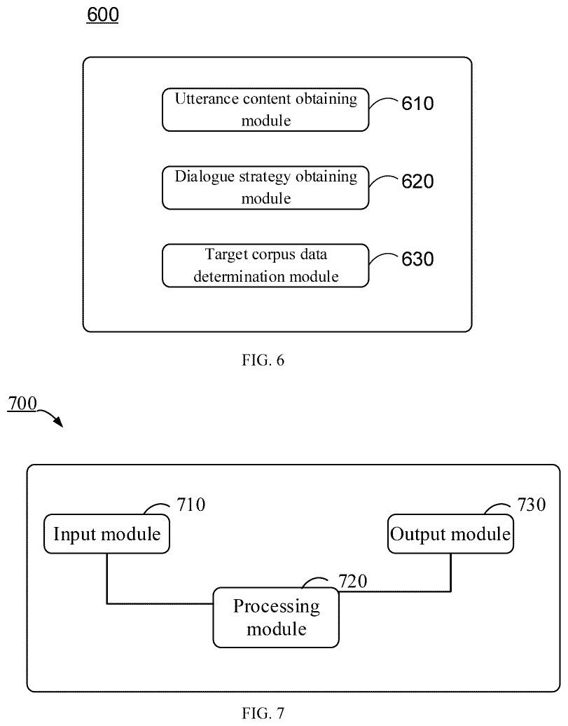

FIG. 6 schematically shows a block diagram of an apparatus for generating corpus data based on large models according to an embodiment of the present disclosure.

As shown in FIG. 6, an apparatus 600 for generating corpus data based on large models includes an utterance content obtaining module 610, a dialogue strategy obtaining module 620, and a target corpus data determination module 630.

The utterance content obtaining module 610 is configured to conduct a dialogue on a predetermined topic by using a plurality of role-based large models to obtain an utterance content of at least one of the role-based large models.

The dialogue strategy obtaining module 620 is configured to perform dialogue strategy planning based on the utterance content by using a designated large model to obtain a dialogue strategy, where the dialogue strategy constrains a speaking pattern of the role-based large models during a dialogue process.

The target corpus data determination module 630 is configured to determine target corpus data related to the predetermined topic according to a target utterance content, where the target utterance content is generated by the role-based large models conducting a dialogue based on the dialogue strategy.

According to an embodiment of the present disclosure, the dialogue strategy obtaining module includes a content quality understanding result obtaining unit, a speaking weight obtaining unit, and a dialogue strategy obtaining unit.

The content quality understanding result obtaining unit is configured to perform semantic understanding on the utterance content by using the designated large model to obtain a content quality understanding result.

The speaking weight obtaining unit is configured to perform a speaking weight adjustment on the role-based large model corresponding to the utterance content according to the content quality understanding result to obtain a speaking weight for the role-based large model, where the speaking weight indicates an expected speaking participation level of the role-based large model during the dialogue process.

The dialogue strategy obtaining unit is configured to determine the dialogue strategy based on the speaking weight.

According to an embodiment of the present disclosure, the content quality understanding result includes a topic relevance information indicating a semantic relevance degree between the utterance content and the predetermined topic; and the speaking weight obtaining unit includes a first adjustment subunit.

The first adjustment subunit is configured to perform a speaking weight adjustment on the role-based large model corresponding to the utterance content according to the topic relevance information.

According to an embodiment of the present disclosure, the content quality understanding result further includes a context relevance information indicating a semantic relevance degree between the utterance content and a context content generated during the dialogue process; and the speaking weight obtaining unit includes a second adjustment subunit.

The second adjustment subunit is configured to perform a speaking weight adjustment on the role-based large model corresponding to the utterance content according to the context relevance information.

According to an embodiment of the present disclosure, the apparatus for generating corpus data based on large models further includes an intermediate utterance content obtaining module and a target utterance content obtaining module.

The intermediate utterance content obtaining module is configured to control, by using the designated large model, the plurality of role-based large models to conduct the dialogue based on the dialogue strategy to obtain an intermediate utterance content.

The target utterance content obtaining module is configured to determine the target utterance content in response to a target interactive operation performed by a target object on the intermediate utterance content.

According to an embodiment of the present disclosure, the target utterance content obtaining module includes an update unit and a target utterance content obtaining unit.

The update unit is configured to, in response to an update operation on the intermediate utterance content, update the intermediate utterance content according to the update operation by using the role-based large model to obtain an updated intermediate utterance content, where the intermediate utterance content and the updated intermediate utterance content are displayed on an interactive interface.

The target utterance content obtaining unit is configured to, in response to an adoption operation on a currently displayed intermediate utterance content on the interactive interface, determine the currently displayed intermediate utterance content as the target utterance content.

According to an embodiment of the present disclosure, the target corpus data is determined based on the target utterance content and an operation information of a target interactive operation related to the target utterance content.

According to an embodiment of the present disclosure, the intermediate utterance content obtaining module includes an event feedback information obtaining unit.

The event feedback information obtaining unit is configured to, in response to a specified event related to the dialogue strategy being triggered, controlling, by using the designated large model, a target role-based large model to perform semantic understanding on the specified event based on an event prompt information corresponding to the specified event in the dialogue strategy to obtain an event feedback information, where the target corpus data is determined based on the event feedback information and the target utterance content, and the specified event is determined by detecting the utterance content during the dialogue process.

According to an embodiment of the present disclosure, the utterance content obtaining module includes a dialogue unit.

The dialogue unit is configured to conduct a dialogue on the predetermined topic by using the plurality of role-based large models based on an initial dialogue strategy, where the initial dialogue strategy is determined by the designated large model performing dialogue strategy planning according to the predetermined topic.

According to an embodiment of the present disclosure, the apparatus for generating corpus data based on large models further includes a display module and an utterance content generation task execution module.

The display module is configured to display a preset instruction element related to a preset prompt instruction.

The utterance content generation task execution module is configured to, in response to a triggering operation on the preset instruction element, prompt, according to an utterance prompt information in the preset prompt instruction, at least one of the role-based large models to perform an utterance content generation task according to the preset prompt instruction, where the role-based large model is allowed to conduct a dialogue with other role-based large models by performing the utterance content generation task.

According to an embodiment of the present disclosure, the target corpus data is determined based on the dialogue strategy, the target utterance content, and a thinking process information of the role-based large model in performing the utterance content generation task.

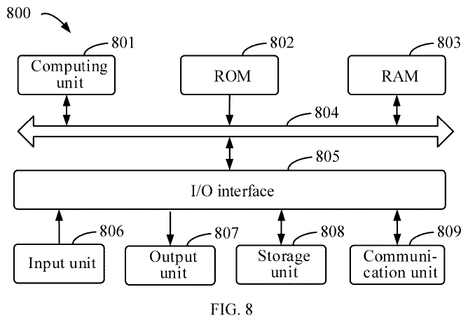

FIG. 7 schematically shows a structural block diagram of an artificial intelligence agent according to an embodiment of the present disclosure.

In an embodiment of the present disclosure, as shown in FIG. 7, an AI agent 700 may include an input module 710, a processing module 720, and an output module 730.

The input module 710 is configured to receive an input information.

The processing module 720 is configured to determine a target task based on the input information received by the input module, determine a role-based large model and a designated large model based on the target task, and perform the method for generating corpus data based on large models provided in embodiments of the present disclosure by invoking the role-based large model and the designated large model, thereby obtaining an output information.

The output module 730 is configured to output the output information obtained by the processing module.

According to an embodiment of the present disclosure, the input module 710 is used to receive or sense information such as queries, requests, instructions, signals or data from the outside world (e.g., users or external environments) and convert the information into a format that the AI agent 700 may understand and process. The input module 710 is a primary link for the AI agent 700 to interact with the outside world, enabling the AI agent 700 to efficiently and accurately acquire necessary “sensory” information from the outside world and make a response to the information.

In an example, the input module 710 may input the aforementioned predetermined topic, dialogue content, and so on.

In an example, the processing module 720 is a core support for the AI agent 700's ability to handle complex tasks. The processing module 720 may perform the method for generating corpus data based on large models described above.

In an example, the performance of the processing module 720 may be closely related to the large model on which the AI agent 700 is based. In order to fully leverage the capabilities of the large model, an internal structure of the processing module 720 may be designed to be highly configurable and scalable, so as to handle various types of tasks and requirements in real-world scenarios.

In an example, after the AI agent 700 acquires the predetermined topic, the processing module 720 may conduct a dialogue on a predetermined topic by using a plurality of role-based large models to obtain an utterance content, perform dialogue strategy planning based on the utterance content by using a designated large model to obtain a dialogue strategy, and transmit a target utterance content generated by the role-based large models conducting a dialogue based on the dialogue strategy to the output module 730.

It may be understood that although the large language models have excellent language understanding and generation capabilities, like humans, their capability to perform tasks are limited without any tools. Once the AI agent 700 is endowed with the ability to invoke tools, it can accomplish tasks such as performing mathematical calculations using a calculator, conducting data analysis using Python, or obtaining weather forecasts using a search engine.

In an example, the output module 730 may output the target utterance content and dialogue strategy mentioned above.

The AI agent 700 according to embodiments of the present disclosure may simply and effectively enhance the level of intelligence and improve flexibility and versatility.

According to an embodiment of the present disclosure, the present disclosure further provides an electronic device, a readable storage medium, and a computer program product.

According to an embodiment of the present disclosure, an electronic device is provided, including: at least one processor; and a memory communicatively connected to the at least one processor. The memory stores instructions executable by the at least one processor, and the instructions are used to, when executed by the at least one processor, cause the at least one processor to implement the method described above.

According to an embodiment of the present disclosure, a non-transitory computer-readable storage medium having computer instructions therein is provided, and the computer instructions are used to cause a computer to implement the method described above.

According to an embodiment of the present disclosure, a computer program product containing a computer program is provided, and the computer program is used to, when executed by a processor, cause the processor to implement the method described above.

FIG. 8 shows a schematic block diagram of an example electronic device that may be used to implement the method for generating corpus data based on large models according to embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 8, the electronic device 800 includes a computing unit 801 which may perform various appropriate actions and processes according to a computer program stored in a read only memory (ROM) 802 or a computer program loaded from a storage unit 8012 into a random access memory (RAM) 803. In the RAM 803, various programs and data necessary for an operation of the electronic device 800 may also be stored. The computing unit 801, the ROM 802 and the RAM 803 are connected to each other through a bus 804. An input/output (I/O) interface 805 is also connected to the bus 804.

A plurality of components in the electronic device 800 are connected to the I/O interface 805, including: an input unit 806, such as a keyboard, or a mouse; an output unit 807, such as displays or speakers of various types; a storage unit 808, such as a disk, or an optical disc; and a communication unit 809, such as a network card, a modem, or a wireless communication transceiver. The communication unit 809 allows the electronic device 800 to exchange information/data with other devices through a computer network such as Internet and/or various telecommunication networks.

The computing unit 801 may be various general-purpose and/or dedicated processing assemblies having processing and computing capabilities. Some examples of the computing units 801 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 801 executes various methods and processes described above, such as the method for generating corpus data based on large models. For example, in some embodiments, the method for generating corpus data based on large models may be implemented as a computer software program which is tangibly embodied in a machine-readable medium, such as the storage unit 808. In some embodiments, the computer program may be partially or entirely loaded and/or installed in the electronic device 800 via the ROM 802 and/or the communication unit 809. The computer program, when loaded in the RAM 803 and executed by the computing unit 801, may execute one or more steps in the method for generating corpus data based on large models described above. Alternatively, in other embodiments, the computing unit 801 may be used to perform the method for generating corpus data based on large models by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the method for generating corpus data based on large models of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method for generating corpus data based on large models, comprising:
conducting a dialogue on a predetermined topic by using a plurality of role-based large models to obtain an utterance content of at least one of the role-based large models;
performing dialogue strategy planning based on the utterance content by using a designated large model to obtain a dialogue strategy, wherein the dialogue strategy constrains a speaking pattern of the role-based large models during a dialogue process; and
determining target corpus data related to the predetermined topic according to a target utterance content, wherein the target utterance content is generated by the role-based large models conducting a dialogue based on the dialogue strategy.

2. The method of claim 1, wherein the performing dialogue strategy planning based on the utterance content by using a designated large model to obtain a dialogue strategy comprises:
performing semantic understanding on the utterance content by using the designated large model to obtain a content quality understanding result;
performing a speaking weight adjustment on the role-based large model corresponding to the utterance content according to the content quality understanding result to obtain a speaking weight for the role-based large model, wherein the speaking weight indicates an expected speaking participation level of the role-based large model during the dialogue process; and
determining the dialogue strategy based on the speaking weight.

3. The method of claim 2, wherein the content quality understanding result comprises a topic relevance information indicating a semantic relevance degree between the utterance content and the predetermined topic;
wherein the performing a speaking weight adjustment on the role-based large model corresponding to the utterance content according to the content quality understanding result comprises:
performing a speaking weight adjustment on the role-based large model corresponding to the utterance content according to the topic relevance information.

4. The method of claim 2, wherein the content quality understanding result further comprises a context relevance information indicating a semantic relevance degree between the utterance content and a context content generated during the dialogue process; and
wherein the performing a speaking weight adjustment on the role-based large model corresponding to the utterance content according to the content quality understanding result comprises:
performing a speaking weight adjustment on the role-based large model corresponding to the utterance content according to the context relevance information.

5. The method of claim 1, wherein the target utterance content is determined by:
controlling, by using the designated large model, the plurality of role-based large models to conduct the dialogue based on the dialogue strategy to obtain an intermediate utterance content; and
determining the target utterance content in response to a target interactive operation performed by a target object on the intermediate utterance content.

6. The method of claim 5, wherein the determining the target utterance content in response to a target interactive operation performed by a target object on the intermediate utterance content comprises:
in response to an update operation on the intermediate utterance content, updating the intermediate utterance content according to the update operation by using the role-based large model to obtain an updated intermediate utterance content, wherein the intermediate utterance content and the updated intermediate utterance content are displayed on an interactive interface; and
in response to an adoption operation on a currently displayed intermediate utterance content on the interactive interface, determining the currently displayed intermediate utterance content as the target utterance content.

7. The method of claim 5, wherein the target corpus data is determined based on the target utterance content and an operation information of a target interactive operation related to the target utterance content.

8. The method of claim 5, wherein the controlling, by using the designated large model, the plurality of role-based large models to conduct the dialogue based on the dialogue strategy comprises:
in response to a specified event related to the dialogue strategy being triggered, controlling, by using the designated large model, a target role-based large model to perform semantic understanding on the specified event based on an event prompt information corresponding to the specified event in the dialogue strategy to obtain an event feedback information; and
wherein the target corpus data is determined based on the event feedback information and the target utterance content, and the specified event is determined by detecting the utterance content during the dialogue process.

9. The method of claim 1, wherein the conducting a dialogue on a predetermined topic by using a plurality of role-based large models comprises:
conducting a dialogue on the predetermined topic by using the plurality of role-based large models based on an initial dialogue strategy, wherein the initial dialogue strategy is determined by the designated large model performing dialogue strategy planning according to the predetermined topic.

10. The method of claim 1, further comprising:
displaying a preset instruction element related to a preset prompt instruction; and
in response to a triggering operation on the preset instruction element, prompting, according to an utterance prompt information in the preset prompt instruction, at least one of the role-based large models to perform an utterance content generation task according to the preset prompt instruction, wherein the role-based large model is allowed to conduct a dialogue with other role-based large models by performing the utterance content generation task.

11. The method of claim 1, wherein the target corpus data is determined based on the dialogue strategy, the target utterance content, and a thinking process information of the role-based large model in performing the utterance content generation task.

12. An electronic device, comprising:
at least one processor; and
a memory communicatively connected to the at least one processor, wherein the memory stores instructions executable by the at least one processor, and the instructions are configured to, when executed by the at least one processor, cause the at least one processor to:
conduct a dialogue on a predetermined topic by using a plurality of role-based large models to obtain an utterance content of at least one of the role-based large models;
perform dialogue strategy planning based on the utterance content by using a designated large model to obtain a dialogue strategy, wherein the dialogue strategy constrains a speaking pattern of the role-based large models during a dialogue process; and
determine target corpus data related to the predetermined topic according to a target utterance content, wherein the target utterance content is generated by the role-based large models conducting a dialogue based on the dialogue strategy.

13. The electronic device of claim 12, wherein the at least one processor is further configured to:
perform semantic understanding on the utterance content by using the designated large model to obtain a content quality understanding result;
perform a speaking weight adjustment on the role-based large model corresponding to the utterance content according to the content quality understanding result to obtain a speaking weight for the role-based large model, wherein the speaking weight indicates an expected speaking participation level of the role-based large model during the dialogue process; and
determine the dialogue strategy based on the speaking weight.

14. The electronic device of claim 13, wherein the content quality understanding result comprises a topic relevance information indicating a semantic relevance degree between the utterance content and the predetermined topic;
wherein the at least one processor is further configured to:
perform a speaking weight adjustment on the role-based large model corresponding to the utterance content according to the topic relevance information.

15. The electronic device of claim 13, wherein the content quality understanding result further comprises a context relevance information indicating a semantic relevance degree between the utterance content and a context content generated during the dialogue process; and
wherein the at least one processor is further configured to:
perform a speaking weight adjustment on the role-based large model corresponding to the utterance content according to the context relevance information.

16. The electronic device of claim 12, wherein the target utterance content is determined by:
controlling, by using the designated large model, the plurality of role-based large models to conduct the dialogue based on the dialogue strategy to obtain an intermediate utterance content; and
determining the target utterance content in response to a target interactive operation performed by a target object on the intermediate utterance content.

17. The electronic device of claim 16, wherein the at least one processor is further configured to:
in response to an update operation on the intermediate utterance content, update the intermediate utterance content according to the update operation by using the role-based large model to obtain an updated intermediate utterance content, wherein the intermediate utterance content and the updated intermediate utterance content are displayed on an interactive interface; and
in response to an adoption operation on a currently displayed intermediate utterance content on the interactive interface, determine the currently displayed intermediate utterance content as the target utterance content.

18. The electronic device of claim 16, wherein the target corpus data is determined based on the target utterance content and an operation information of a target interactive operation related to the target utterance content.

19. The electronic device of claim 16, wherein the at least one processor is further configured to:
in response to a specified event related to the dialogue strategy being triggered, control, by using the designated large model, a target role-based large model to perform semantic understanding on the specified event based on an event prompt information corresponding to the specified event in the dialogue strategy to obtain an event feedback information; and
wherein the target corpus data is determined based on the event feedback information and the target utterance content, and the specified event is determined by detecting the utterance content during the dialogue process.

20. A non-transitory computer-readable storage medium having computer instructions therein, wherein the computer instructions, when executed by a processor, are configured to cause a computer to:
conduct a dialogue on a predetermined topic by using a plurality of role-based large models to obtain an utterance content of at least one of the role-based large models;
perform dialogue strategy planning based on the utterance content by using a designated large model to obtain a dialogue strategy, wherein the dialogue strategy constrains a speaking pattern of the role-based large models during a dialogue process; and
determine target corpus data related to the predetermined topic according to a target utterance content, wherein the target utterance content is generated by the role-based large models conducting a dialogue based on the dialogue strategy.
